(19) United States
(12) Patent Application Publication
(10) Pub. No.: US 2012/0242184 A1
(43) Pub. Date: Sep. 27, 2012

(54) Non-360 Degree Driving Brushless DC Motor

(75) Inventor: Yongjian Hu, New Territories (HK)

(73) Assignee: HOBA International (Motor) Group Ltd., New Territories (HK)

(21) Appl. No.: 13/395,432

(22) PCT Filed: Sep. 9, 2009
(86) PCT No.: PCT/CN09/01015

§ 371 Date: May 29, 2012

(51) Int. Cl. H02K 3/18; H02K 15/00; H02K 15/03

(52) U.S. Cl. 310/208; 29/598; 29/596

(57) ABSTRACT

A brushless DC motor comprises: a rotor on which magnetic poles evenly arranged along the circumferential direction thereof; and a stator on which a plurality of coils are disposed. The coils are unevenly distributed along the circumference of the stator.

### FIELD OF THE INVENTION

The present invention relates to a motor. More specifically, the invention relates to a non-360-degree driving motor, in particular to a non-360-degree driving brushless DC motor.

### BACKGROUND OF THE INVENTION

The brushless DC motor is widely used as a driving device in electronic equipment (particularly small sized electronic equipment) due to the advantages of high efficiency, wide range of speed adjustment, small volume, long service life, easiness in control and the like. The small sized electronic equipment are diverse, and the magnitudes of driving torques required by different electronic equipment are different, so the output torque of the brushless DC motor serving as the driving device should be matched with the load of the electronic equipment as required.

In the prior art, the output torque of the brushless DC motor is generally adjusted in the following steps to match the driven load: 1) the number of stator coils and rotor magnets are simultaneously increased or reduced in accordance with a certain proportion, and the number of the coils and that of the magnets should be 3:2 or 3:4 after the increment/reduction; and 2) the thickness of a magnetic core silicon steel sheet of the motor is changed. As a result, it is inconvenient for the assembly in the production process, and the production cost is inevitably increased.

### SUMMARY OF THE INVENTION

In view of the above, a brushless DC motor needs to be provided. The brushless DC motor can simultaneously increase or reduce the number of the stator coils and rotor magnets disproportionably, the thickness of the magnetic core silicon steel sheet needs no change, and the brushless DC motor can be easily assembled and is low in production cost.

Therefore, in one aspect, the invention provides a brushless DC motor, comprising:

a rotor, on which magnetic poles are evenly arranged along the circumferential direction thereof; and

a stator, on which a plurality of coils are disposed;

the brushless DC motor is characterized in that the coils are unevenly distributed along the circumference of the stator.

In one embodiment of the invention, the number of coils is 3n, and the number of the magnetic poles is 2m, wherein, n is a natural number greater than or equal to 1 and m is a natural number greater than or equal to 1.

In one embodiment of the invention, n is equal to 1, m is greater than 2, and the circumferential angle occupied by the 3n coils on the circumference of the stator corresponds to the circumferential angle occupied by 4 continuous magnetic poles on the circumference of the rotor.

In one embodiment of the invention, n is equal to 1, m is greater than 1, and the circumferential angle occupied by 3 coils on the circumference of the stator corresponds to the circumferential angle occupied by 2 continuous magnetic poles on the circumference of the rotor.

In one embodiment of the invention, n is greater than 1, m is greater than 4n, and the circumferential angle occupied by the 3n coils on the circumference of the stator corresponds to the circumferential angle occupied by 4n continuous magnetic poles on the circumference of the rotor.

In one embodiment of the invention, n is greater than 1, m is greater than 2n, and the circumferential angle occupied by the 3n coils on the circumference of the stator corresponds to the circumferential angle occupied by 2n continuous magnetic poles on the circumference of the rotor.

In one embodiment of the invention, n is greater than 1, m is greater than 4n, the circumferential angle occupied by 3 coils of the first group in the 3n coils on the circumference of the stator corresponds to the circumferential angle occupied by 4 continuous magnetic poles of the first group on the circumference of the rotor, the circumferential angle occupied by 3 coils of the second group on the circumference of the stator corresponds to the circumferential angle occupied by 4 continuous magnetic poles of the second group on the circumference of the rotor, and the 4 magnetic poles of the first group are not adjacent to the 4 magnetic poles of the second group.

In one embodiment of the invention, n is greater than 1, m is greater than 2n, the circumferential angle occupied by 3 coils of the first group in the 3n coils on the circumference of the stator corresponds to the circumferential angle occupied by 2 continuous magnetic poles of the first group on the circumference of the rotor, the circumferential angle occupied by 3 coils of the second group on the circumference of the stator corresponds to the circumferential angle occupied by 2 continuous magnetic poles of the second group on the circumference of the rotor, and the 2 magnetic poles of the first group are not adjacent to the 2 magnetic poles of the second group.

In one embodiment of the invention, every 3 coils in the 3n coils form a group, and the position of each group is in rotational symmetry about the axis of the brushless DC motor.

An external driving structure or an internal driving structure can be adopted in the motor.

The magnetic poles are preferably permanent magnets.

In another aspect, the invention provides a method for adjusting the output torque of the brushless DC motor. The method comprises any one, two or three of the following steps:

changing the number of the magnetic poles;

changing the number of the coils;

and changing the diameter of the motor.

According to the above technical solutions, the output torque and the revolving speed of the brushless DC motor can be easily adjusted by simply changing the number of the permanent magnets and changing the radius of the rotor at the same time to meet the requirement of the load. Certainly, more accurate load matching can be realized by simultaneously changing the number of the stator coils and the number of the rotor magnets and adjusting the radius of the rotor.

### BRIEF DESCRIPTION OF THE DRAWINGS

The above and other characteristics and purposes of the invention can be better comprehended according to the following detailed exemplary embodiments shown in the drawings, in which:

FIG. 1 illustrates structural schematic figures of two typical brushless DC motors;

FIG. 2 schematically illustrates the measures taken to change the output torque of the brushless DC motor in the prior art;

FIG. 3 is a schematic diagram of a first embodiment of the invention;

FIG. 4 is a schematic diagram of a second embodiment of the invention;

FIG. 5 is a schematic diagram of a third embodiment of the invention;

FIG. 6 is a schematic diagram of a fourth embodiment of the invention;

FIG. 7 is a schematic diagram of a fifth embodiment of the invention; and

FIG. 8 is a schematic diagram of a sixth embodiment of the invention.

### DETAILED DESCRIPTION OF THE EMBODIMENTS

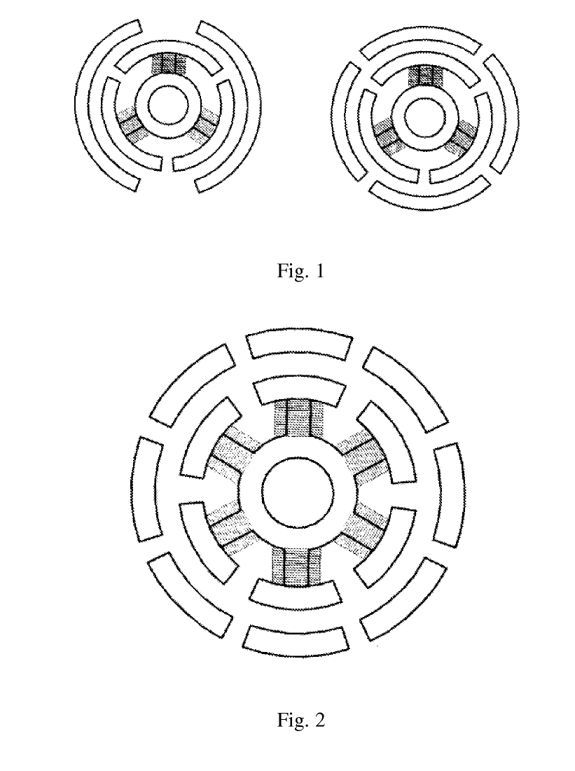

FIG. 1 illustrates structural schematic diagrams of two typical brushless DC motors, wherein, a rotor of a motor a comprises magnetic poles consisting of 2 permanent magnets, and a stator comprises 3 coils evenly distributed in the circumferential direction. A rotor of a motor b comprises magnetic poles consisting of 4 permanent magnets, and a stator comprises 3 coils evenly distributed in the circumferential direction.

The mechanical and electrical parameters (for example, the radius of the rotor is set to be 7 mm) of the motors a and b can be set as follows: the rated torque is 0.05 N·m (Newton·meter), and the rated revolving speed is 5,000 rpm (revolutions per minute).

As mentioned, the electronic equipment driven by brushless DC motors are diverse, and the magnitudes of the loads are variable, so the output torque, the revolving speed and the like of the brushless DC motors serving as driving devices should be matched with the electronic equipment as required. In the prior art, to change the output torque of the brushless DC motor, the number of the magnetic poles of the rotor and the number of the stator coils should be simultaneously changed based on the two basic structures as shown in FIG. 1, and the number of the magnetic poles of the rotor and that of the stator coils should be maintained as 3:2 or 3:4 after changed.

FIG. 2 illustrates a method for changing the output torque of the brushless DC motor, wherein, the number of the magnetic poles of the rotor is changed from 4 to 8, the number of the stator coils is changed from 3 to 6, and the radius of the rotor is unchanged and is still 7 mm When other parameters are unchanged, the output torque of the motor is 0.05*(6/3)=0.1 N·m, and the revolving speed of the motor is 2,500 rpm.

In the above structure, when the number of the magnetic poles of the rotor and that of the stator coils are simultaneously adjusted, the production and assembly costs are high.

According to the invention, the stator coils of the brushless DC motor are not evenly but asymmetrically arranged on the whole circumference. Therefore, when the output torque required by the load is matched, the output torque and the revolving speed can be adjusted only by increasing or reducing the number of the magnetic poles of the rotor and simultaneously increasing or reducing the radius of the rotor when other parameters are unchanged.

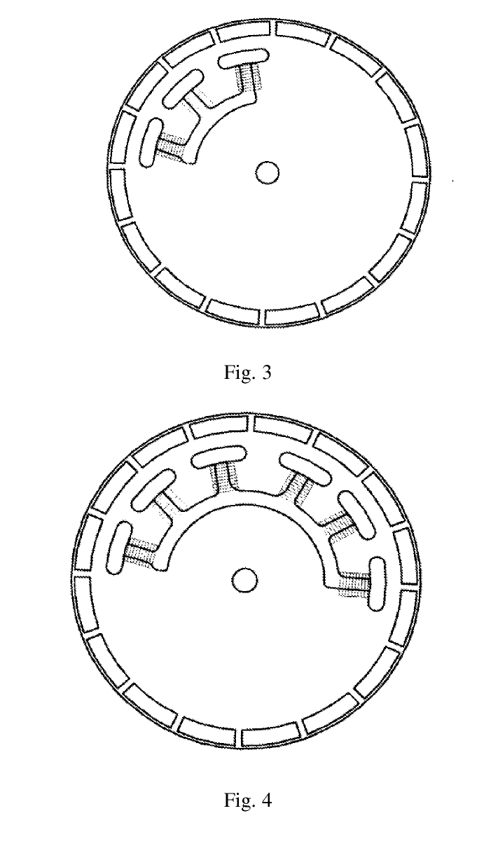

FIG. 3 illustrates a first embodiment of the invention. In the embodiment, the number of the stator coils is unchanged, the number of the magnetic poles of the rotor is changed from 4 to 16, the radius of the rotor is changed from 7 mm to 28 mm, and other parameters are the same as those of the motor shown in FIG. 1.

As shown in FIG. 3, when the positions of the stator coils of the motor are set, 3 coils are not evenly arranged along the circumference of the stator, but the positions of the 3 coils on the circumference of the stator are set as the circumferential angle occupied by the 3 coils together corresponds to the circumferential angle occupied by 4 continuous magnetic poles on the rotor.

According to the revolving speed formula of the brushless DC motor:

r=120f/p,

wherein, f represents the frequency of the stator current, p represents the number of the magnetic poles of the rotor, and r represents the revolving speed. When other parameters are unchanged and only the number of the magnetic poles is changed, the revolving speed of the motor in the embodiment is 5,000*4/16=1,250 rpm. Meanwhile, according to the torque formula, when other parameters are the same, and the electromagnetic induction properties of the stator and the rotor are the same, the output torque of the motor is in proportion to the radius of the rotor. In the embodiment, when other parameters are unchanged and only the radius of the rotor is changed from 7 mm to 28 mm, the output torque is 0.05*28/7=0.2 N·m.

FIG. 4 illustrates the second embodiment of the invention. In the embodiment, the number of the stator coils is 6, the number of the magnetic poles of the rotor is 16, the radius of the rotor is 28 mm, and other parameters are the same as those of the motor shown in FIG. 1. According to the revolving speed formula of the brushless DC motor:

r=120f/p,

the revolving speed of the motor in the embodiment is 5,000*4/16=1,250 rpm. Meanwhile, according to the torque formula, the output torque is 0.05*(28/7)*(6/3)=0.4 N·m.

As shown in FIG. 4, 6 coils are not evenly arranged along the circumference of the stator, but the positions of the 6 coils on the circumference of the stator are set as the circumferential angle occupied by the 6 coils together corresponds to the circumferential angle occupied by 8 continuous magnetic poles on the rotor.

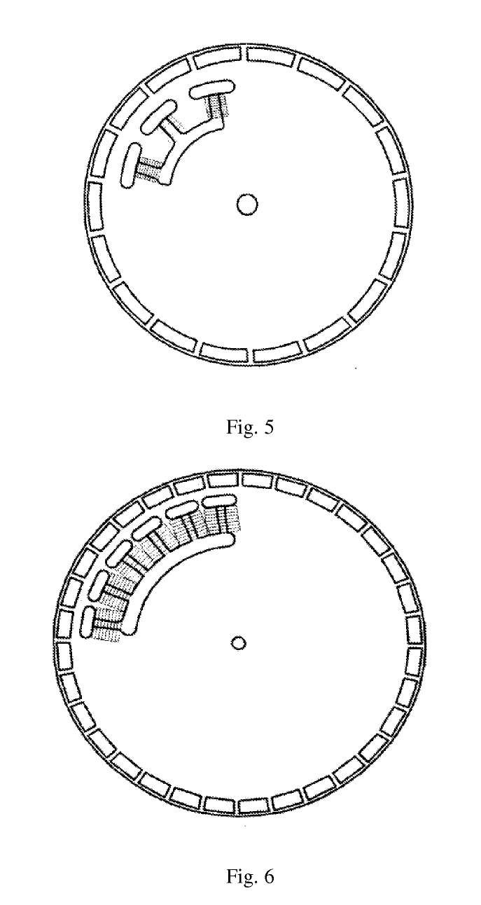

FIG. 5 illustrates the third embodiment of the invention. In the embodiment, the number of the stator coils is 3, the number of the magnetic poles of the rotor is 18, the radius of the rotor is 32 mm, and other parameters are the same as those of the motor shown in FIG. 1. According to the revolving speed formula of the brushless DC motor:

r=120f/p,

the revolving speed of the motor in the embodiment is 5,000*4/18=1,111 rpm. Meanwhile, according to the torque formula, the output torque is 0.05*(32/7)=0.23 N·m.

FIG. 6 illustrates the fourth embodiment of the invention. In the embodiment, the number of the stator coils is 6, the number of the magnetic poles of the rotor is 32, the radius of the rotor is 56 mm, and other parameters are the same as those of the motor shown in FIG. 1. According to the revolving speed formula of the brushless DC motor:

r=120f/p,

the revolving speed of the motor in the embodiment is 5,000*4/32=625 rpm. Meanwhile, according to the torque formula, the output torque is 0.05*(56/7)*(6/3)=0.8 N·m.

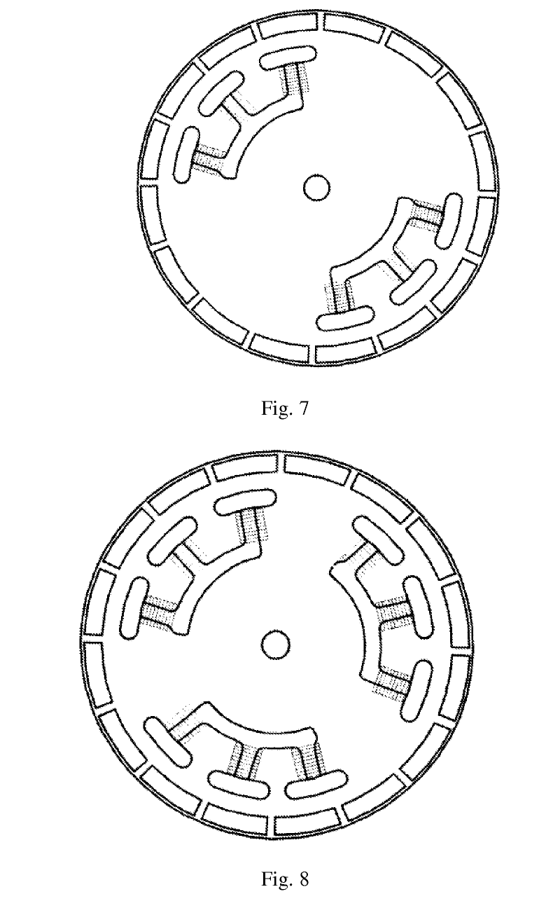

FIG. 7 illustrates the fifth embodiment of the invention. The structure of the motor in the embodiment is similar to that in the second embodiment shown in FIG. 4, and the output revolving speed and the output torque of the motor, similar to those in the second embodiment, are respectively 1,250 rpm and 0.4 N·m. Different from the second embodiment, 3 coils of the first group in the 6 stator coils are substantially symmetrical to the other 3 coils of the second group, so that the rotor is stressed symmetrically and the working state of the motor is improved.

FIG. 8 illustrates the sixth embodiment of the invention. In the embodiment, the number of the stator coils is 9, the number of the magnetic poles of the rotor is 16, the radius of the rotor is 28 mm, and other parameters are the same as those of the motor shown in FIG. 1. According to the revolving speed formula of the brushless DC motor:

r=120f/p,

the revolving speed of the motor in the embodiment is 5,000*4/16=1,250 rpm. Meanwhile, according to the torque formula, the output torque is 0.05*(28/7)*(9/3)=0.6 N·m.

In the embodiment, every 3 coils of one group in the 9 coils are substantially symmetrical on the circumference, so that the rotor is stressed symmetrically and the working state of the motor is improved.

Certainly, in the embodiments shown in FIG. 7 and FIG. 8, the positions of coils of one group and the coils of other groups can be asymmetrical, and the purposes of the invention can also be fulfilled.

In all the above embodiments, the magnetic poles are preferably permanent magnets.

After the technical solution is adopted, the output torque of the motor can be easily adjusted. Specifically, the method for adjusting the output torque of the motor can comprise a step of separately changing the diameter of the motor, or a step of separately changing the number of the magnetic poles of the motor, or a step of separately changing the number of the coils of the motor, or any combination of the three steps.

The above embodiments describe the basic principles of the invention. In the embodiments, the typical external driving brushless DC motor is described, the coils are statically arranged in the interior, and the permanent magnets are arranged in the exterior and rotate when the motor works. Certainly, the skilled in the art will appreciate easily that the principles of the invention are also suitable for the internal driving brushless DC motor.

Moreover, in each embodiment, the positions of 3 coils of each group of the stator on the circumference of the stator are set such that the circumferential angle occupied by the 3 coils together corresponds to the circumferential angle occupied by 4 continuous magnetic poles on the rotor. The skilled in the art will appreciate easily that the relationship between the magnetic poles of the rotor and the stator coils can also be set, so that the circumferential angle occupied by 3 coils of each group of the stator together corresponds to the circumferential angle occupied by 2 continuous magnetic poles on the rotor.

Therefore, the scope of the invention is defined by appended claims rather than the embodiments described herein.

1. A brushless DC motor, comprising:
a rotor, on which magnetic poles are evenly arranged along a circumferential direction thereof; and
a stator, on which a plurality of coils are disposed;
the brushless DC motor is characterized in that the plurality of coils are unevenly distributed along a circumference of the stator.

2. The brushless DC motor of claim 1, wherein, the number of the coils is 3n, and the number of the magnetic poles is 2m, n is a natural number greater than or equal to 1 and m is a natural number greater than or equal to 1.

3. The brushless DC motor of claim 2, wherein, n is equal to 1, m is greater than 2, and the circumferential angle occupied by the 3n coils on the circumference of the stator corresponds to the circumferential angle occupied by 4 continuous magnetic poles on the circumference of the rotor.

4. The brushless DC motor of claim 2, wherein, n is equal to 1, m is greater than 1, and the circumferential angle occupied by 3 coils on the circumference of the stator corresponds to the circumferential angle occupied by 2 continuous magnetic poles on the circumference of the rotor.

5. The brushless DC motor of claim 2, wherein, n is greater than 1, m is greater than 4n, and the circumferential angle occupied by the 3n coils on the circumference of the stator corresponds to the circumferential angle occupied by 4n continuous magnetic poles on the circumference of the rotor.

6. The brushless DC motor of claim 2, wherein, n is greater than 1, m is greater than 2n, and the circumferential angle occupied by the 3n coils on the circumference of the stator corresponds to the circumferential angle occupied by 2n continuous magnetic poles on the circumference of the rotor.

7. The brushless DC motor of claim 2, wherein, n is greater than 1, m is greater than 4n, the circumferential angle occupied by 3 coils of the first group in the 3n coils on the circumference of the stator corresponds to the circumferential angle occupied by 4 continuous magnetic poles of the first group on the circumference of the rotor, the circumferential angle occupied by 3 coils of the second group in the 3n coils on the circumference of the stator corresponds to the circumferential angle occupied by 4 continuous magnetic poles of the second group on the circumference of the rotor, and the 4 magnetic poles of the first group are not adjacent to the 4 magnetic poles of the second group.

8. The brushless DC motor of claim 2, wherein, n is greater than 1, m is greater than 2n, the circumferential angle occupied by 3 coils of the first group in the 3n coils on the circumference of the stator corresponds to the circumferential angle occupied by 2 continuous magnetic poles of the first group on the circumference of the rotor, the circumferential angle occupied by 3 coils of the second group in the 3n coils on the circumference of the stator corresponds to the circumferential angle occupied by 2 continuous magnetic poles of the second group on the circumference of the rotor, and the 2 magnetic poles of the first group are not adjacent to the 2 magnetic poles of the second group.

9. The brushless DC motor of claim 7, wherein, every 3 coils in the 3n coils form a group, and the position of each group is in rotational symmetry about the axis of the brushless DC motor.

10. The brushless DC motor of claim 1, wherein, an external driving structure is adopted in the motor.

11. The brushless DC motor of claim 1, wherein, an internal driving structure is adopted in the motor.

12. The brushless DC motor of claim 1, wherein, the magnetic poles are permanent magnets.

13. A method for adjusting an output torque of a brushless DC motor, wherein, the brushless DC motor comprises:
a rotor, on which magnetic poles are evenly arranged along a circumferential direction thereof; and
a stator, on which a plurality of coils are disposed;
and the coils are unevenly distributed along a circumference of the stator;
the method comprises the following step:
changing the number of the magnetic poles.

14. A method for adjusting an output torque of a brushless DC motor, wherein, the brushless DC motor comprises:
a rotor, on which magnetic poles are evenly arranged along a circumferential direction thereof; and
a stator, on which a plurality of coils are disposed;
and the coils are unevenly distributed along a circumference of the stator;
the method comprises the following step:
changing the number of the coils.

15. A method for adjusting an output torque of a brushless DC motor, wherein, the brushless DC motor comprises:
a rotor, on which magnetic poles are evenly arranged along a circumferential direction thereof; and
a stator, on which a plurality of coils are disposed;
and the coils are unevenly distributed along a circumference of the stator;
the method comprises the following step:
changing the diameter of the motor.

16. (canceled)

17. The brushless DC motor of claim 8, wherein, every 3 coils in the 3n coils form a group, and the position of each group is in rotational symmetry about the axis of the brushless DC motor.

18. The method for adjusting an output torque of a brushless DC motor according to claim 14, further comprising:
changing the number of the magnetic poles; and
changing the diameter of the motor.
